(19) United States
(12) Patent Application Publication
(10) Pub. No.: US 2026/0147582 A1
(43) Pub. Date: May 28, 2026

(54) BOOT PROCESS OF ELECTRONIC DEVICE AND CHIP OF ELECTRONIC DEVICE

(71) Applicant: Sigmastar Technology Ltd., Xiamen (CN)

(72) Inventors: QUANMING WU, Shanghai (CN); WEISHENG DU, Shanghai (CN); YANXIONG WU, Shanghai (CN)

(21) Appl. No.: 19/374,573

(22) Filed: Oct. 30, 2025

(30) Foreign Application Priority Data
Nov. 26, 2024 (CN) 202411707082.3

(51) Int. Cl. G06F 9/4401

(52) U.S. Cl. CPC G06F 9/4403; G06F 9/4411

(57) ABSTRACT

A chip is coupled to an external memory, a peripheral interface circuit, and a storage device. The storage device stores external memory information and multiple external memory initialization files. The chip includes an interface control circuit, a memory, and a computing circuit. The interface control circuit is configured to control the peripheral interface circuit. The computing circuit is configured to execute program codes and/or program instructions stored in the memory to perform the following steps:
obtaining a value through the peripheral interface circuit; generating an index value based on the value; determining a target external memory initialization file from the external memory initialization files based on the index value and the external memory information; and loading an external memory parameter from the target external memory initialization file into the memory.

This application claims the benefit of China application Serial No. CN 202411707082.3, filed on Nov. 26, 2024, the subject matter of which is incorporated herein by reference.

### BACKGROUND OF THE INVENTION

### 1. Field of the Invention

The present invention generally relates to an electronic device, and more particularly, to a boot process and a chip of the electronic device.

### 2. Description of Related Art

Reference is made to FIG. 1, which shows the boot process of a conventional electronic device. The boot process 100 includes the read-only memory (ROM) execution procedure 110 and the boot loader execution procedure 120. The ROM execution procedure 110 includes initializing the central processing unit (CPU) (step S112) and loading and running the MiniBoot (step S114). The boot loader execution procedure 120 includes initializing the memory (e.g., a dynamic random access memory (DRAM)) (step S122), loading and running the U-boot (step S124), initializing the peripheral devices (step S126), and loading and running the kernel (step S128). The details of the boot process 100 are well known to people having ordinary skill in the art, so further elaboration is omitted for brevity.

From FIG. 1, it can be seen that the code used for initializing the memory is hardcoded into the source code of the boot loader execution procedure 120, and the two are compiled to generate a boot loader image. That is to say, one boot loader image corresponds to only one type of memory. The disadvantage of this design is that the manufacturer of the chip (which does not include the memory initialized in step S122) must prepare multiple boot loader images to accommodate different types of memory, which increases the time and complexity of product development.

### SUMMARY OF THE INVENTION

In view of the issues of the prior art, an object of the present invention is to provide a boot process and a chip of an electronic device, so as to make an improvement to the prior art.

According to one aspect of the present invention, a chip is provided. The chip is coupled to an external memory, a peripheral interface circuit, and a storage device. The storage device stores external memory information and a plurality of external memory initialization files. The chip includes an interface control circuit, a memory, and a computing circuit. The interface control circuit controls the peripheral interface circuit. The memory stores a plurality of program codes and/or program instructions. The computing circuit is coupled to the interface control circuit and the memory and is configured to execute the program codes and/or program instructions to perform the following steps: obtaining a value through the peripheral interface circuit; generating an index value based on the value; determining a target external memory initialization file from the plurality of external memory initialization files according to the index value and the external memory information; and loading an external memory parameter from the target external memory initialization file into the memory.

According to another aspect of the present invention, a boot process of an electronic device is provided. The electronic device includes a chip, an external memory, a peripheral interface circuit, and a storage device. The storage device stores external memory information and a plurality of external memory initialization files. The boot process includes the following steps: obtaining a value through the peripheral interface circuit; generating an index value based on the value; determining a target external memory initialization file from the plurality of external memory initialization files according to the index value and the external memory information; and loading an external memory parameter from the target external memory initialization file into a memory within the chip.

According to still another aspect of the present invention, a boot process of an electronic device is provided. The electronic device includes a chip, an external memory, and a storage device. The storage device stores external memory information, a first external memory parameter, and a second external memory parameter. The boot process includes the following steps: selecting the first external memory parameter according to the external memory information, wherein the first external memory parameter corresponds to the external memory; loading the first external memory parameter into a memory within the chip before initialization of the external memory; and executing the first external memory parameter to initialize the external memory. During the initialization of the external memory, the memory stores the first external memory parameter, the storage device stores the second external memory parameter, and the first external memory parameter is different from the second external memory parameter.

The technical means embodied in the embodiments of the present invention can solve at least one of the problems of the prior art. Therefore, compared to the prior art, the present invention can reduce the time and complexity of developing a product.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows the boot process of a conventional electronic device.

FIG. 2 is a functional block diagram of the electronic device according to an embodiment of the present invention.

FIG. 3 is a flowchart of the boot process of the electronic device according to an embodiment of the present invention.

FIG. 4 is a schematic diagram of the external memory initialization data according to an embodiment of the present invention.

FIG. 5 is the flowchart of the external memory parameter loading procedure according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a boot process and a chip of an electronic device. On account of that some or all elements of the electronic device could be known, the detail of such elements is omitted provided that such detail has little to do with the features of this disclosure, and that this omission nowhere dissatisfies the specification and enablement requirements. Some or all of the boot process of the electronic device may be implemented by software and/or firmware and can be performed by the chip or its equivalent. A person having ordinary skill in the art can choose components or steps equivalent to those described in this specification to carry out the present invention, which means that the scope of this invention is not limited to the embodiments in the specification.

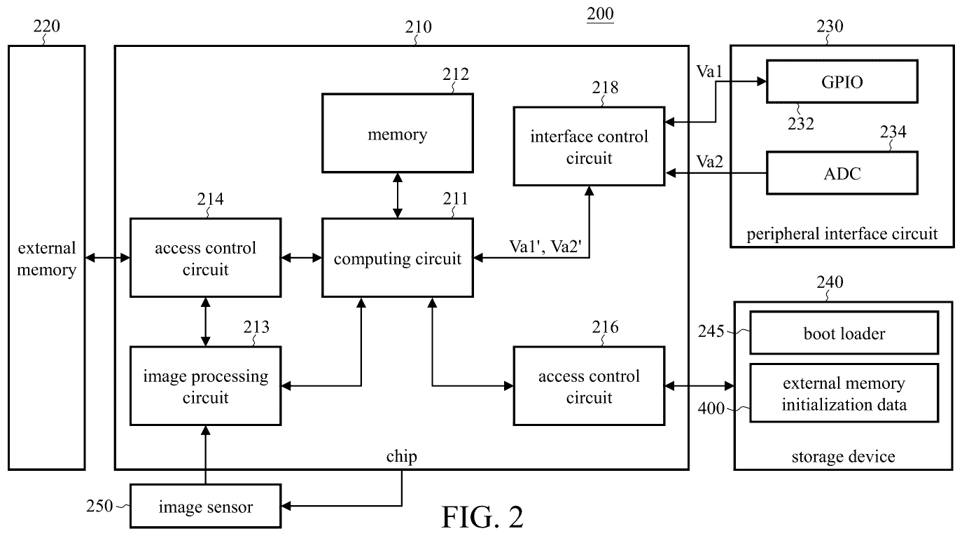

Reference is made to FIG. 2, which is a functional block diagram of the electronic device according to an embodiment of the present invention. The electronic device 200 includes a chip 210, an external memory 220, a peripheral interface circuit 230, a storage device 240, and an image sensor 250, all of which are coupled to each other. The external memory 220 may be a volatile memory (e.g., a DRAM), while the storage device 240 may be a non-volatile memory (e.g., a flash memory).

The peripheral interface circuit 230 includes a general-purpose input/output (GPIO) 232 and an analog-to-digital converter (ADC) 234. The GPIO 232 and the ADC 234 are each a type of interface circuit. The ADC 234 includes but is not limited to a successive-approximation register (SAR) analog-to-digital converter (SAR ADC) and/or a pulse width modulation (PWM) analog-to-digital converter (PWM ADC).

The storage device 240 stores the boot loader 245 and the external memory initialization data 400.

The chip 210 includes the computing circuit 211, a memory 212, an image processing circuit 213, an access control circuit 214, an access control circuit 216, and an interface control circuit 218, all of which are coupled to each other. In some embodiments, the chip 210 may be an image processing chip.

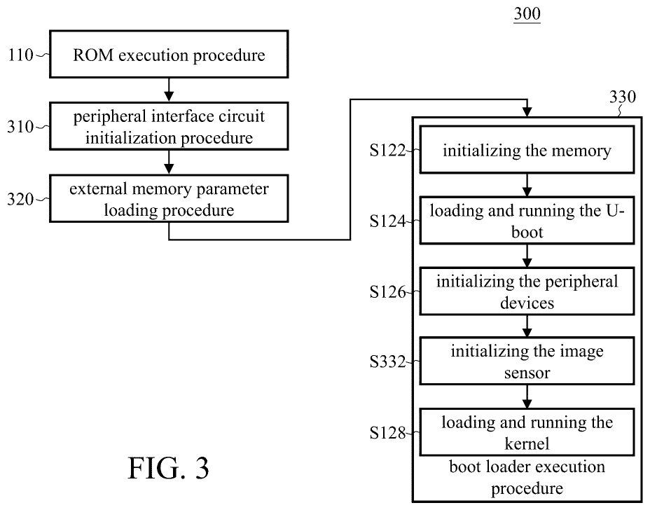

The computing circuit 211 may be a circuit or electronic component with program execution capability, such as a central processing unit, a microprocessor, a microcontroller unit, a digital signal processor, an application-specific integrated circuit (ASIC), or an equivalent circuit. The computing circuit 211 implements some functions of the chip 210 by executing the program codes and/or program instructions stored in the memory 212. Those functions include but are not limited to the boot process 300 of the electronic device 200 (which will be discussed in detail below with reference to FIG. 3) and image processing.

The memory 212 may be a volatile memory, for example, a Static Random Access Memory (SRAM).

The image processing circuit 213 may be an image signal processor (ISP) configured to process the image signals captured by the image sensor 250 and store the results to the external memory 220 through the access control circuit 214.

The access control circuit 214 and the access control circuit 216 are used to control access to the external memory 220 and the storage device 240, respectively. The computing circuit 211 accesses the external memory 220 and the storage device 240 respectively through the access control circuit 214 and the access control circuit 216. The computing circuit 211 can load the boot loader 245 into the memory 212 through the access control circuit 216 to execute the boot loader execution procedure 330 of the boot loader 245 (which will be detailed below with reference to FIG. 3).

The interface control circuit 218 is used to control at least one interface circuit of the peripheral interface circuit 230. More specifically, the interface control circuit 218 obtains an input signal Va1 and an input signal Va2 (e.g., signals such as voltage and current, or corresponding digital signals) inputted to the electronic device 200 through the GPIO 232 and the ADC 234, respectively, and then transmits the value Va1′ corresponding to the input signal Va1 and the value Va2′ corresponding to the input signal Va2 to the computing circuit 211. In other embodiments, the interface control circuit 218 can also transmit the input signal Va1 and the input signal Va2 directly to the computing circuit 211.

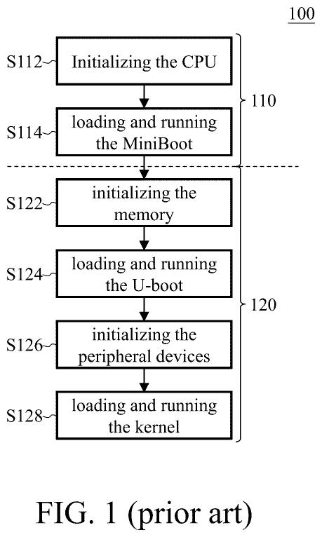

Reference is made to FIG. 3, which is a flowchart of the boot process of the electronic device 200 according to an embodiment of the present invention. The boot process 300 is executed by the computing circuit 211 and includes the ROM execution procedure 110, the peripheral interface circuit initialization procedure 310, the external memory parameter loading procedure 320, and the boot loader execution procedure 330. The details of the ROM execution procedure 110 are shown in FIG. 1, so further elaboration is omitted for brevity. In addition to steps S122, S124, S126, and S128 (where the memory in step S122 refers to the external memory 220), the boot loader execution procedure 330 includes the initialization of the system of the electronic device 200 (including, but not limited to, resetting the state and registers of the computing circuit 211, configuring the clock and power management, and initializing the storage device 240, etc.), and the initialization of the image sensor 250 (step S332).

The peripheral interface circuit initialization procedure 310 and the external memory parameter loading procedure 320 are between the ROM execution procedure 110 and the boot loader execution procedure 330. The peripheral interface circuit initialization procedure 310 and the external memory parameter loading procedure 320 are stored in the memory 212 in the form of program codes and/or program instructions. The computing circuit 211 executes the peripheral interface circuit initialization procedure 310 and the external memory parameter loading procedure 320 by executing the program codes and/or program instructions.

The peripheral interface circuit initialization procedure 310 is used to initialize the peripheral interface circuit 230. After the peripheral interface circuit initialization procedure 310 is completed, the computing circuit 211 can obtain the input signal Va1 and the input signal Va2 or the value Va1′ and the value Va2′ through the interface control circuit 218. The initialization of the peripheral interface circuit 230 is well known to people having ordinary skill in the art, so further elaboration is omitted for brevity.

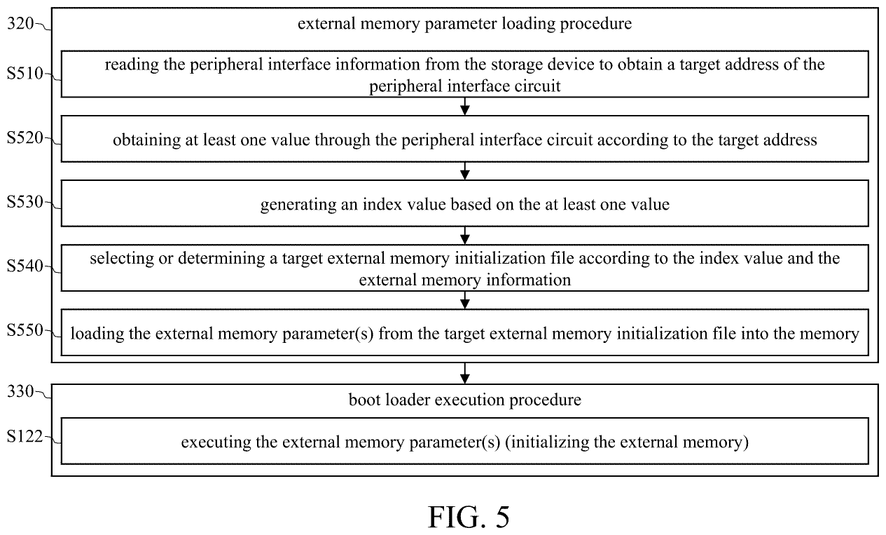

The details of the external memory parameter loading procedure 320 will be discussed in detail below with reference to FIG. 5.

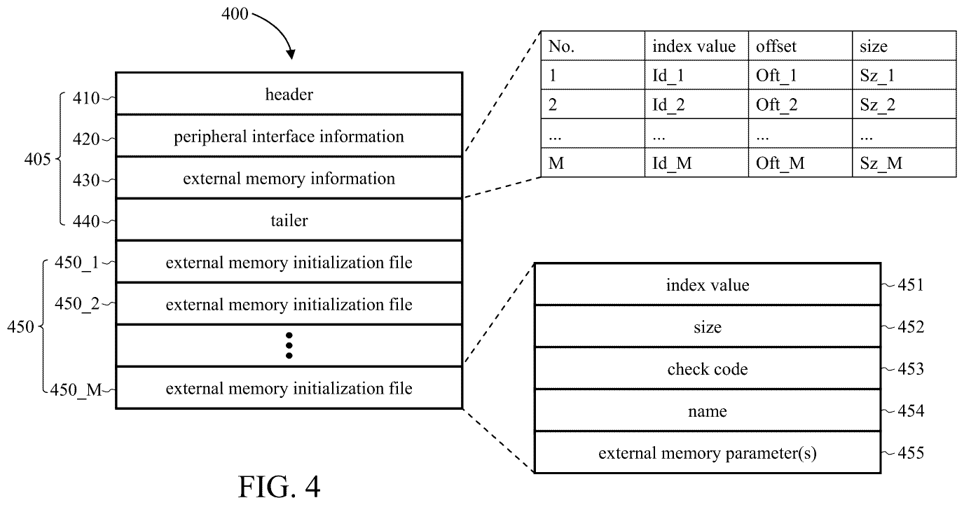

Reference is made to FIG. 4, which is a schematic diagram of the external memory initialization data 400 according to an embodiment of the present invention. The external memory initialization data 400 includes basic information 405 and M external memory initialization files 450 (including 450_1, 450_2, . . . , 450_M, where M is an integer greater than 1). The basic information 405 includes the header 410, the peripheral interface information 420, the external memory information 430, and the tailer 440. The M external memory initialization files are all different from each other. More specifically, the M external memory initialization files have different external memory parameter(s) 455.

The header 410 is used to indicate the start of the external memory initialization data 400 and contains a check code as well as the version and size information of the external memory initialization data 400.

The peripheral interface information 420 indicates from which addresses of the peripheral interface circuit 230 the input signal Va1 and the input signal Va2 should be read, and how these input signals should be quantized into the value Va1′ and the value Va2′. For example, the peripheral interface information 420 can record the third wire and the fifth wire of the GPIO 232, and/or the first channel of the ADC 234. In some embodiments, the interface control circuit 218 may first perform discretization or resolution reduction on the input signal Va2 and then provide the value Va2′ to the computing circuit 211.

In other embodiments, the interface control circuit 218 does not perform quantization of the input signal but directly provides the input signal Va1 and the input signal Va2 to the computing circuit 211. The computing circuit 211 quantizes the input signal Va1 and the input signal Va2 to generate the value Va1′ and the value Va2′.

The external memory information 430 records the index table of the external memory initialization files 450. As shown in FIG. 4, the external memory information 430 includes the numbers (1 to M), the index values (Id_1, Id_2, . . . , Id_M), the offsets (Oft_1, Oft_2, . . . , Oft_M) relative to the tailer 440, and the sizes (Sz_1, Sz_2, . . . , Sz_M) of the external memory initialization files 450. The computing circuit 211 can find the corresponding external memory initialization file (one of 450_1 to 450_M) according to the index value and read the corresponding external memory initialization file from the storage device 240 according to the offset and size.

The index value may be the value Va1′, the value Va2′, or a combination of the two. For example, the index value can be equal to the value Va1′ (e.g., the signal on the third wire and the signal on the fifth wire of the GPIO 232 correspond to the first bit and the second bit of the index value, respectively); the index value can be equal to the value Va2′ (e.g., the output code of the first channel of the ADC 234); or, the index value can be equal to the combination of the value Va1′ and the value Va2′ (e.g., the higher 2 bits are the value Va1′, while the lower 4 bits are the value Va2′).

The tailer 440 is used to indicate the end of the basic information 405.

Each external memory initialization file 450 contains multiple data. Taking the external memory initialization file 450_M as an example, the file contains an index value 451 (Id_M), a size 452 (Sz_M), a check code 453, a name 454, and the external memory parameter(s) 455.

The check code 453 is used to check whether the external memory initialization file 450_M is correct.

The name 454 allows the user to check whether the selected external memory initialization file is correct when executing the external memory parameter loading procedure 320.

The external memory parameter(s) 455 correspond(s) to the initialization of a certain type of the external memory 220. The initialization includes but is not limited to the setting and calibration of timing, the setting of voltage, etc.

As shown in FIG. 4, the storage device 240 stores multiple external memory initialization files 450, and the computing circuit 211 can select, according to the index value, the external memory initialization file 450 that matches the external memory 220 to perform the initialization of the external memory 220. From FIG. 2 and FIG. 3, it can be seen that the present invention places the external memory initialization data 400 outside the boot loader 245. Therefore, the external memory initialization data 400 is not a part of the boot loader 245. In other words, the external memory initialization file 450 is not hardcoded into the boot loader 245. Moreover, the external memory parameter loading procedure 320 and the boot loader execution procedure 330 are separate procedures. Therefore, the manufacturer of the chip 210 only needs to prepare one boot loader image (i.e., the boot loader 245), and does not need to prepare multiple boot loader images according to multiple different types of the external memory 220, greatly simplifying the chip manufacturing process. This can reduce the time and complexity of developing the product.

Reference is made to FIG. 5, which is a flowchart of the external memory parameter loading procedure 320 according to an embodiment of the present invention. The external memory parameter loading procedure 320 is executed by the computing circuit 211 and includes the following steps.

Step S510: Reading the peripheral interface information 420 from the storage device 240 to obtain a target address of the peripheral interface circuit 230. After obtaining the peripheral interface information 420, the computing circuit 211 can determine the definition of the index value (e.g., the value Va1′, the value Va2′, or a combination of the two) from the peripheral interface information 420 and determine the target address of the peripheral interface circuit 230. For example, the target address indicates a certain wire or certain wires of the GPIO 232, and/or a certain channel or certain channels of the ADC 234.

Step S520: Obtaining at least one value (e.g., the value Va1′ and/or the value Va2′) through the peripheral interface circuit 230 according to the target address. More specifically, the computing circuit 211 controls the interface control circuit 218 to read, based on the target address, the input signal Va1 and/or the input signal Va2 inputted to the peripheral interface circuit 230. In addition, in some embodiments, the computing circuit 211 configures the interface control circuit 218 according to the peripheral interface information 420, and then the interface control circuit 218 quantizes the input signal Va1 and/or the input signal Va2 to provide the value Va1′ and/or the value Va2′ to the computing circuit 211. In other embodiments, the computing circuit 211 obtains the input signal Va1 and/or the input signal Va2 from the interface control circuit 218, and then quantizes the input signal Va1 and/or the input signal Va2 according to the peripheral interface information 420 to generate the value Va1′ and/or the value Va2′.

Step S530: Generating an index value (Id_1, Id_2, . . . , Id_M) based on the at least one value. As mentioned earlier, the index value may be the value Va1′, the value Va2′, or a combination of the two.

Step S540: Selecting or determining a target external memory initialization file according to the index value and the external memory information 430. For example, according to the index value Id_M and the index table of the external memory information 430, the computing circuit 211 can find the corresponding external memory initialization file 450_M as the target external memory initialization file.

Step S550: Loading the external memory parameter(s) from the target external memory initialization file into the memory 212. Continuing from the previous example, after finding the external memory initialization file 450_M, the computing circuit 211 reads the external memory parameter(s) 455 of the external memory initialization file 450_M from the storage device 240 through the access control circuit 216, and stores the external memory parameter(s) 455 in the memory 212. The external memory parameter(s) 455 will be executed in subsequent steps (i.e., the memory initialization step S122 of the boot loader execution procedure 330) to initialize the external memory 220.

In summary, although the storage device 240 stores multiple external memory initialization files 450, in the external memory parameter loading procedure 320, the computing circuit 211 loads only one of the external memory initialization files 450 into the memory 212. In other words, although the boot process 300 of this invention supports multiple types of external memory, when the initialization procedure of the external memory 220 (i.e., step S122 of the boot process 300) is being executed, the memory 212 stores only a set of external memory parameter(s) 455 that match the external memory 220, while at the same time, the storage device 240 stores at least another set of different external memory parameter(s) 455. That is to say, compared to the prior art, the present invention does not require a larger memory 212. It should be noted that the cost of the storage device 240 is much less than the cost of the memory 212.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A chip, coupled to an external memory, a peripheral interface circuit, and a storage device storing external memory information and a plurality of external memory initialization files, the chip comprising:
an interface control circuit configured to control the peripheral interface circuit;
a memory configured to store a plurality of program codes and/or program instructions; and
a computing circuit coupled to the interface control circuit and the memory and configured to execute the program codes and/or program instructions to perform following steps:
obtaining a value through the peripheral interface circuit;
generating an index value based on the value;
determining a target external memory initialization file from the external memory initialization files according to the index value and the external memory information; and
loading an external memory parameter from the target external memory initialization file into the memory.

2. The chip of claim 1, wherein the storage device further stores peripheral interface information, and the computing circuit further performs following steps:
reading the peripheral interface information to obtain a target address of the peripheral interface circuit;
wherein the step of obtaining the value through the peripheral interface circuit obtains the value based on the target address.

3. The chip of claim 2, wherein the peripheral interface circuit comprises a general-purpose input/output (GPIO), the target address corresponds to at least one wire of the GPIO, and the value corresponds to a signal on the at least one wire.

4. The chip of claim 2, wherein the peripheral interface circuit comprises an analog-to-digital converter (ADC), the target address corresponds to at least one channel of the ADC, and the value corresponds to at least one output code of the at least one channel.

5. The chip of claim 2, wherein the peripheral interface circuit comprises a first interface circuit and a second interface circuit, the interface control circuit obtains a first value and a second value from the first interface circuit and the second interface circuit, respectively, and the index value is a combination of the first value and the second value.

6. The chip of claim 1, wherein the chip is further coupled to an image sensor, the storage device further stores a boot loader, and the computing circuit further performs following steps:
executing a boot loader execution procedure of the boot loader after loading the external memory parameter into the memory; and
executing the external memory parameter to initialize the external memory in a memory initialization step of the boot loader execution procedure;
wherein the boot loader is used to reset a state of the computing circuit and to initialize at least one register, the storage device, and the image sensor.

7. The chip of claim 6, wherein initialization of the image sensor occurs later than initialization of the external memory.

8. A boot process of an electronic device, the electronic device comprising a chip, an external memory, a peripheral interface circuit, and a storage device, the storage device storing external memory information and a plurality of external memory initialization files, the boot process comprising following steps:
obtaining a value through the peripheral interface circuit;
generating an index value based on the value;
determining a target external memory initialization file from the plurality of external memory initialization files according to the index value and the external memory information; and
loading an external memory parameter from the target external memory initialization file into a memory within the chip.

9. The boot process of claim 8, wherein the storage device further stores peripheral interface information, and the boot process further comprises following steps:
reading the peripheral interface information to obtain a target address of the peripheral interface circuit;
wherein the step of obtaining the value through the peripheral interface circuit obtains the value based on the target address.

10. The boot process of claim 9, wherein the peripheral interface circuit comprises a general-purpose input/output (GPIO), the target address corresponds to at least one wire of the GPIO, and the value corresponds to a signal on the at least one wire.

11. The boot process of claim 9, wherein the peripheral interface circuit comprises an analog-to-digital converter (ADC), the target address corresponds to at least one channel of the ADC, and the value corresponds to at least one output code of the at least one channel.

12. The boot process of claim 9, wherein the peripheral interface circuit comprises a first interface circuit and a second interface circuit, the step of obtaining the value through the peripheral interface circuit obtains a first value and a second value from the first interface circuit and the second interface circuit, respectively, and the index value is a combination of the first value and the second value.

13. The boot process of claim 8, wherein the electronic device further comprises a computing circuit and an image sensor, the storage device further stores a boot loader, and the boot process further comprises following steps:
executing a boot loader execution procedure of the boot loader after loading the external memory parameter into the memory; and
executing the external memory parameter to initialize the external memory in a memory initialization step of the boot loader execution procedure;
wherein the boot loader is used to reset a state of the computing circuit and to initialize at least one register, the storage device, and the image sensor.

14. The boot process of claim 13, wherein initialization of the image sensor occurs later than initialization of the external memory.

15. A boot process of an electronic device, the electronic device comprising a chip, an external memory, and a storage device, the storage device storing external memory information, a first external memory parameter, and a second external memory parameter, the boot process comprising following steps:
selecting the first external memory parameter according to the external memory information, wherein the first external memory parameter corresponds to the external memory;
loading the first external memory parameter into a memory within the chip before initialization of the external memory; and
executing the first external memory parameter to initialize the external memory;
wherein during the initialization of the external memory, the memory stores the first external memory parameter, the storage device stores the second external memory parameter, and the first external memory parameter is different from the second external memory parameter.

16. The boot process of claim 15, wherein the electronic device further comprises a peripheral interface circuit, and the boot process further comprises following steps:
obtaining a value through the peripheral interface circuit;
generating an index value based on the value; and
selecting the first external memory parameter according to the index value.

17. The boot process of claim 16, wherein the storage device further stores peripheral interface information, and the boot process further comprises following steps:
reading the peripheral interface information to obtain a target address of the peripheral interface circuit;
wherein the step of obtaining the value through the peripheral interface circuit obtains the value based on the target address.

18. The boot process of claim 16, wherein the peripheral interface circuit comprises a first interface circuit and a second interface circuit, the step of obtaining the value through the peripheral interface circuit obtains a first value and a second value from the first interface circuit and the second interface circuit, respectively, and the index value is a combination of the first value and the second value.

19. The boot process of claim 15, wherein the electronic device further comprises a computing circuit and an image sensor, the storage device further stores a boot loader, the step of executing the first external memory parameter to initialize the external memory is a part of the boot loader, and the boot loader is used to reset a state of the computing circuit and to initialize at least one register, the storage device, and the image sensor.
